(19) United States
(12) Patent Application Publication
(10) Pub. No.: US 2002/0047867 A1
(43) Pub. Date: Apr. 25, 2002

(54) Image based diet logging

(76) Inventors: James R. Mault, Evergreen, CO (US); John Sanderson, Bainbridge Island, WA (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 09/949,244

(22) Filed: Sep. 7, 2001

Related U.S. Application Data
(60) Provisional application No. 60/230,860, filed on Sep. 7, 2000.
(60) Provisional application No. 60/234,154, filed on Sep. 21, 2000.

(51) Int. Cl. G06F 3/00

(52) U.S. Cl. 345/810

(57) ABSTRACT

A method for assisting a person create a record of food items consumed by the person comprises the capturing of food images corresponding to food items consumed, for example by creating an image using an optical image sensor; recording the food images in the memory of an electronic device; viewing the food images on the display of the electronic device, so as to identify food items consumed; selecting food item identifiers corresponding to the food images; and recording food item identifiers in a memory, so as to create a record of food items consumed.

### REFERENCE TO RELATED APPLICATION

This application claims priority from U.S. provisional patent application Serial No. 60/230,860, filed Sep. 7, 2000, the entire contents of which is incorporated herein by reference.

### FIELD OF THE INVENTION

The invention relates to the recording of consumables consumed, in particular to diet logging using methods comprising image recording.

### BACKGROUND OF THE INVENTION

Conventional diet calculators allow a person to enter to select a food identifier, such as a food name, so as to obtain a calorie content for the food. However, the creation of a diet log (a record of food items consumed) for a person by conventional methods is time consuming and inconvenient.

U.S. Pat. No. 5,233,520 to Kretsch, et al. discloses an interactive dietary measurement system including a video camera and recorder means. However, this system does not provide a method for selecting food item identifiers from a displayed menu, or for transmitting images to a remote computer system for analysis so as to create a diet log.

### SUMMARY OF THE INVENTION

Methods and apparatus are provided to assist a person to create a diet log, or record of foods consumed. The term “food” will be used to refer to all consumables, such as meals, snacks, drinks, and nutraceuticals. Embodiments of the present invention allow medication administration to be monitored.

A method of creating a record of foods consumed, or diet log, comprises recording images corresponding to the foods consumed. An image corresponding to a food item consumed can comprise an image of the food, food package, label, menu listing, barcode (such as a Universal Product Code or UPC), food serving on a plate, food serving in a restaurant package, package containing multiple food servings, alphanumeric codes, receipts, printed data (such as nutritional information conventionally found on food packages), notes written or typed about the food, and the like.

Images can be recorded of a food item before eating, and additional images recorded of a portion of any food remaining after eating, so as to allow the determination of the amount of food consumed, such as the fraction of a portion consumed.

The image can be stored, for example, on the memory of an imaging device such as a camera, a memory of a device in communication with the imaging device, a memory module (such as a memory stick), a memory of a portable computing device, or on a memory associated with a remote computer system, such as one accessible over a communications network. In this context, the term image refers to an electronic file, or equivalent, containing information corresponding to an image. An example would be a conventional JPEG file.

After recording the image, at a convenient later time the person can retrieve a stored image and view the image on a display. The display can be part of the imaging device, or other device such as a personal digital assistant, personal computer, Internet appliance, WebTV, e-book, tablet computer, pager, cell phone, interactive TV, spectacle mounted display, visor, and the like. An electronic device having a display used to view an image may be in communication with a separate device used to create the image, for example using wireless or cable-based links.

The person can select a food name corresponding to the displayed image. For example, the person can be presented with a menu of food types, such as described by Williams in U.S. Pat. Nos. U.S. Pat. Nos. 5,704,350 and 4,891,756, incorporated herein by reference. The person selects a food type from the presented menu and is then presented with a list of food names within the selected type. Food names may include product names, descriptions, trademarks, and also stored images can be presented. The person selects a food item identifier corresponding to viewed image, the food item identifier then being recorded in a memory so as to create a diet log for the person. The food item identifier can be correlated with nutritional content, such as caloric content, using a database.

The imaging device, used to create an image of foods consumed, can be a digital camera, device having the functionality of a camera, such as a personal digital assistant (PDA), cell phone, electronic book, pager, calculator, or other consumer electronics device. The imaging device can also be an ornamental component, clothing item, or other functional or decorative item having image creation capabilities, such as spectacles, buttons, a pen, cutlery item, key ring, keys, belt, cigarette-like object, ring, body ornament, or jewelry.

For example, a pen can have one end adapted for writing and a second end comprising an optical image sensor, battery, and wireless transmitter adapted to transmit captured images to a device in proximity, such as a PDA.

An imaging device can comprise elements such as an optical imaging sensor such as a charge coupled device (CCD), a memory, a memory slot adapted to receive a memory module such as a non-volatile memory module, an electrical power source, a transceiver, a clock, a display, an electrical interface, an audible signal generator, an indicator light, a data port (such as a socket for a cable), an IR transmitter or transceiver, or other wireless transceiver.

Hence, a method of recording items consumed by a person, comprises: providing the person with an imaging device; having the person obtain at least one image of each item consumed; identifying items consumed from the images; obtaining nutritional information for the items consumed; and creating a diet log based on the nutritional information consumed.

A method for assisting a person create a record of food items consumed by the person comprises: creating food images corresponding to food items consumed, for example by creating an image using an optical image sensor; recording the food images on the memory of an electronic device further having a display, a processor, and a clock; viewing the food images on the display of the electronic device, so as to identify food items consumed,; selecting food item identifiers corresponding to the food images; and recording food item identifiers in a memory, so as to create a record of food items consumed. The time at which food was consumed can also be viewed at along with the food image using time data provided by a clock at the time the data was created. One or more menus, for example of food types and/or food names, can presented on the display of the electronic device along with the food images, allowing a person to select food item identifiers from the menus. Alternatively, voice recognition, eyeball tracking, a stylus, roller, track-ball, roller jog dial, buttons, keys, or other data entry mechanism can be used to select data. The selection of data can comprise the entering of a food name, food code, or entering a number or the like corresponding to a menu listing. Images can created using a digital camera, or an optical image sensor which is part of the electronic device, or an optical image sensor camouflaged as a decorative or functional item such as a button, jewelry, glasses, pen, pencil, button, or other item. The electronic device can be a portable computer, such as a personal digital assistant.

A method of creating a record of a food item consumed comprises: recording a food image of the food item consumed; viewing the food image on a display; entering a food item identifier, such as a food item name corresponding to the food image, into the electronic device using any appropriate data entry mechanism; and recording the food item name in a memory of the electronic device so as to create a record of food items consumed. The food image can be recorded in a memory of the electronic device, or any other memory accessible to the electronic device, such as a memory module, remote database, and the like. The food item name can be selected from one or more lists of food item names presented on the display of the electronic device, for example from one or more menus presented on the display.

A method of creating a diet log comprises: recording an image of a label, the label corresponding to a food item consumed; analyzing the image of the label (for example using optical character recognition, image analysis, image recognition, or neural network techniques) so as to determine the identity of the food item consumed; and storing the determined identity of the food item consumed in an electronic memory, so as to create a diet log. The label can be a printed label, a barcode, an alphanumeric code, a nutritional data label, a list of ingredients, a product code, graphical designs (such as trademarks), product names, and the like. The identity of food items consumed can be correlated with nutritional data, for example using a nutritional database, and the nutritional data can stored in an electronic memory so as to create a nutritional record, for example as part of a diet log.

A method by which a person can create a record of foods consumed comprises: recording a food image of a food consumed; transmitting the food image to a remote computer system, for example over a communications network such as the Internet; receiving food identification data from the remote computer system (which may be generated by a software running on the remote computer system, a computer expert system, an image analysis system, a human operative in communication with the remote computer system, or some combination of techniques); and recording the food identification data so as to create a record of foods consumed.

A system for determining the calorie balance of a person comprises: a portable computing device, having a display, a processor, a memory, and a clock, and a data receiver; an activity monitor, providing a activity signal correlated with the activity level of the person, the activity signal being transmitted to the portable computing device; an imaging system, adapted to record food images of food consumed by the person; and a software application program, executed by the processor of the portable computing device, adapted to present food images to the person on the display, and further adapted to receive food identification data from the person corresponding to food images presented on the display. The system can further comprise an indirect calorimeter, which provides a determination of a resting metabolic rate of the person. The software application program can be adapted to receive the resting metabolic rate of the person from the indirect calorimeter, or to estimate it from the Harris-Benedict equation or similar.

A system for assisting a person create a record of foods consumed comprises; a computing device, comprising a processor, a memory, a clock, and a display; an imaging system, in communication with the computing device, comprising an optical imaging sensor, and a imaging control mechanism, so as to allow the person to capture food images corresponding to foods consumed by the person; and a software application program, executed by the processor, adapted to display food images to the person, to accept corresponding food identifier data from the person, and to store the food item identifier data in the memory, so as to create a record of foods consumed by the person. The software application program can be further adapted to display a menu of food item identifiers to the person. An activity sensor can provide a signal correlated with the physical activity of the person, which can be communicated to the computing device (for example using wireless transmissions), so as to allow a determination of activity energy expenditure of the person. The software application program can be adapted to calculate a calorie balance for the person, for example using an activity signal, metabolic rate data determined using an indirect calorimeter, and caloric intake of the person determined from the diet log created from the images. The system can further comprise other physiological sensors, such as a blood glucose sensor in communication with the computing device, or a sensor sensitive to eating, chewing, and the like. Images can be automatically captured when eating is detected.

An imaging sensor having a two-dimensional array of sensor elements can capture an image by having the array exposed to the image, so as to create an electronic data set or file corresponding to the spatial distribution of intensity (and color, if required) of the image. The file can be stored in short term memory, for immediate review by the person, or in long term memory for review later. The term “food image” is used to refer to a file, other data set, or transmitted electronic data containing data corresponding to an image of food, food packaging, or other item associated with food. The term image is used in a similar way. Images may be of foods or other items, or may be stored as reminders of activities. For example, an image of an exercise machine can be stored so as to remind the person later of an activity performed.

### BRIEF DESCRIPTION OF THE DRAWING

FIG. 1A shows a schematic of an electronic device which can be used in embodiments of the present invention;

FIG. 1B shows a schematic of an imaging system which can be used in embodiments of the present invention;

FIG. 2 illustrates a portable computing device which can be used in embodiments of the present invention;

FIG. 3 shows menu options presented on a display;

FIG. 4 illustrates a method of creating a diet log;

FIG. 5 illustrates a system allowing diet log creation;

FIG. 6 illustrates a further method of creating a diet log;

FIG. 7 shows illustrates a system for creating a diet log, including an interactive television;

FIG. 8 illustrates a further method of creating a diet log;

FIG. 9 shows a further system allowing diet log creation;

FIG. 10 shows a further system allowing diet log creation;

FIG. 11 shows an image of a food item on a display of an electronic device;

FIG. 12 shows an image of a barcode on a display of an electronic device;

FIG. 13 shows an image of nutritional data on a display of an electronic device;

FIG. 14 shows a system by which images can be transferred from a camera to an electronic device, for purposes of diet logging;

FIGS. 15 and 16 show a wrist-mounted imaging system, which can be used in embodiments of the present invention.

### DETAILED DESCRIPTION OF THE PREFERRED EMBODIMENTS

### Diet Logging Using Portable Electronic Device

A person can be provided with a portable electronic device, having an image creation capability. For example, the portable electronic device may be a personal digital assistant (PDA) having an optical image sensor. The optical image sensor can be an accessory to the PDA, or can be within the housing of the PDA. The portable electronic device may also be a digital camera, wireless telephone, pager, organizer, calculator (numeric calculator, diet calculator, graphing calculator), spectacle mounted device, wrist mounted device, or other electronic device having image production capabilities.

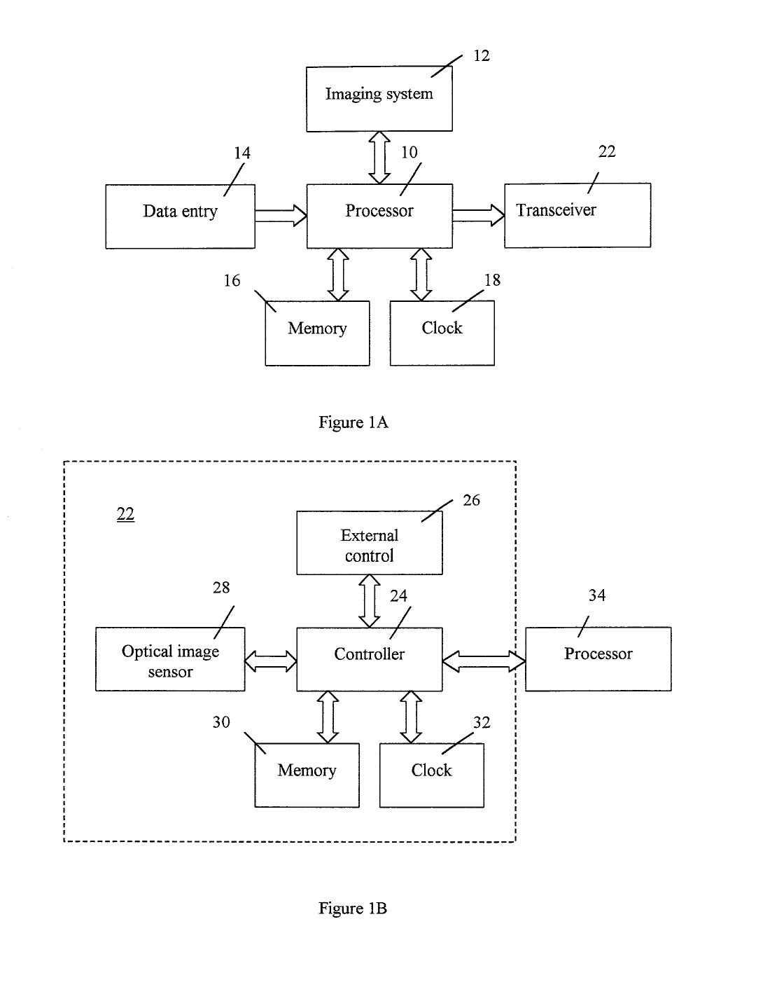

FIG. 1A shows a schematic of an electronic device which may be used in embodiments of the present invention, having a processor 10, an image capturing system 12, a data entry mechanism 14, a memory 16, a clock 18, and display 18.

FIG. 1B illustrates a schematic of an image capturing system, which may be used in embodiments of the present invention, comprising an optical image sensor 22, a controller 24, an external control 26 (for example a button pressed by the user), a memory 30 and a clock 32. A connection is shown to a processor 34 of an electronic device, such as that described in FIG. 1A, other components of the electronic device are omitted for clarity. On receiving a signal from the external control or from the processor, the controller 24 initiates the capture of an image by sensor 28, and may store the image in memory 30 along with a time stamp provided by clock 32.

The communication between the image capturing system and the processor can be provided, for example, by an internal data bus within a PDA, a cable link between two separate devices, or a wireless communication link such as using the Blue Tooth protocol.

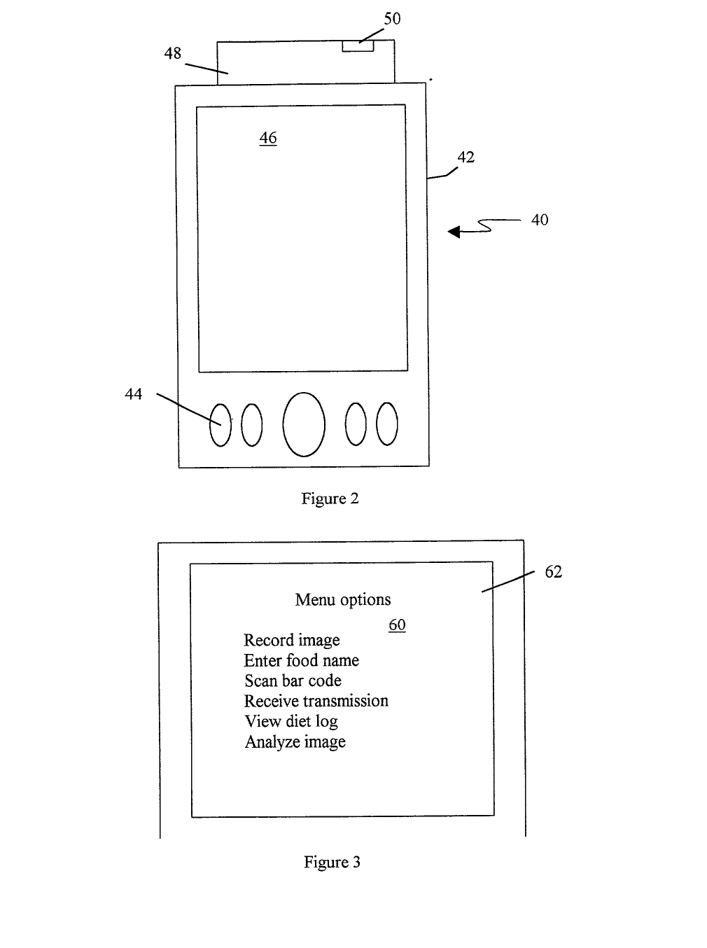

FIG. 2 illustrates an electronic device (PDA), shown generally at 40. The PDA has housing 42, data input mechanism 44 in the form of data entry buttons, a display 46, and a plug in module 48 comprising an optical image sensor 50. The plug in module may also comprise a memory containing a database for use with a diet log software program. The PDA also comprises a processor, memory, clock, and associated components within the housing 42.

A software application program, executed by the processor of the electronic device, can be used to present a menu of diet log options to a person on the display of the electronic device. A plug in module may provide both the optical image sensor and a database, stored in a memory within the module, of food items, for example as described by Williams in U.S. Pat. Nos. 5,704,350 and 4,891,756, incorporated herein by reference.

Other electronic devices which may be used in embodiments of the present invention include a wireless phone having a camera, for example as disclosed U.S. Pat. No. 6,219,560 to Erkkila et al., incorporated herein by reference, or other portable electronic device having a connection to a camera, for example as described in U.S. Pat. No. 5,475,441 to Parulski et al., incorporated herein by reference.

FIG. 3 shows a possible presentation 60 on a display 62 of an electronic device, such as a PDA. Options presented to a person include an image recording option. For example, the person may select the image recording option, then direct the optical image sensor at a food item about to be consumed, and press a button (or wait a certain time period) to capture an image of the food.

Other options which may be presented to the user include the entering of a food by name, for example into diet log software, or scanning the barcode of a food item. The electronic device may comprise or communicate with a barcode scanner, or the optical image sensor can be used to record an image of the barcode. The barcode can then be interpreted in terms of a UPC (universal product code) and/or product name using a database accessible to the PDA. A UPC database may be accessible over a communications network such as the Internet. Other options include receiving transmissions such as wireless data transmissions from food vendors or food vending devices, viewing the recorded diet log, editing the diet log, or analyzing previously recorded images.

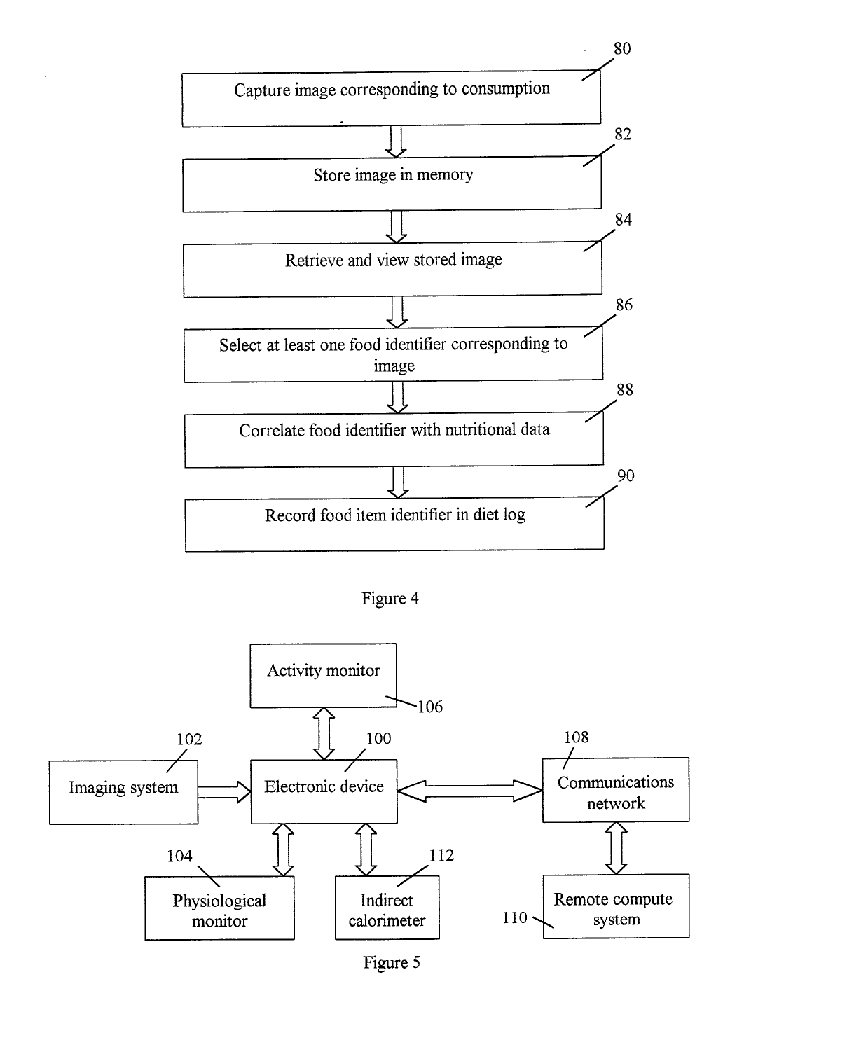

FIG. 4 is a flow chart illustrating a method of recording images. Box 80 corresponds to capturing an image of food consumed. For convenience, we will assume that a single image is captured, however more than one image can be captured if necessary or convenient. Box 82 corresponds to storing the image in a memory of the electronic device. Box 84 corresponds to retrieving the image from memory and viewing the image on a display of the electronic device, or other device in communication with the electronic device. The time and location that the image was recorded can also be recorded in memory and displayed, so as to assist diet logging. Box 88 corresponds to selecting a food item identifier, such as a food name, corresponding to the displayed image. The selection can be made from a menu displayed to the person. Box 88 corresponds to correlating a food item identifier with nutritional data. Box 90 corresponds to recording the food item identifier and corresponding nutritional data in memory, so as to create a diet log. The step corresponding to box 88 can be omitted, and corresponding nutritional data can be identified after the food identifier is stored in memory. The food item identifier can be a food name, product code, barcode, and the like.

### Electronic Device in Communication with Remote Computer

FIG. 5 is a schematic of a system comprising an electronic device 100, an imaging system 102, a physiological sensor 104, an activity sensor 106, and a communications link through communications network 108 to a remote computer system (such as a server system) 110. The electronic device can be a PDA or other device carried by the person. The imaging device can be included with the electronic device in a unitary device. The physiological sensor may detect eating, for example a blood glucose sensor can detect the rise in blood glucose after a meal, allowing the electronic device to alert the person to make a diet log entry. The activity sensor provides a signal correlated with a physical activity level of the person.

Images recorded with the imaging device are transmitted over the communications network to the remote computer. The remote computer system can be a server system, and may comprise a computer expert system for image analysis. Image analysis can be performed by one or more persons, a computer expert system, or other mechanism.

Images can be recorded automatically. For example, the image sensor can be included in a spectacle mount, jewelry, or other object, and the image recording automatically triggered so as to record images related to eating, activity, or other predetermined condition. The trigger, or alert to the person to record an image, can arise from signals provided by a clock, a combination of time and GPS, physiological sensor, activity sensor, or other information source.

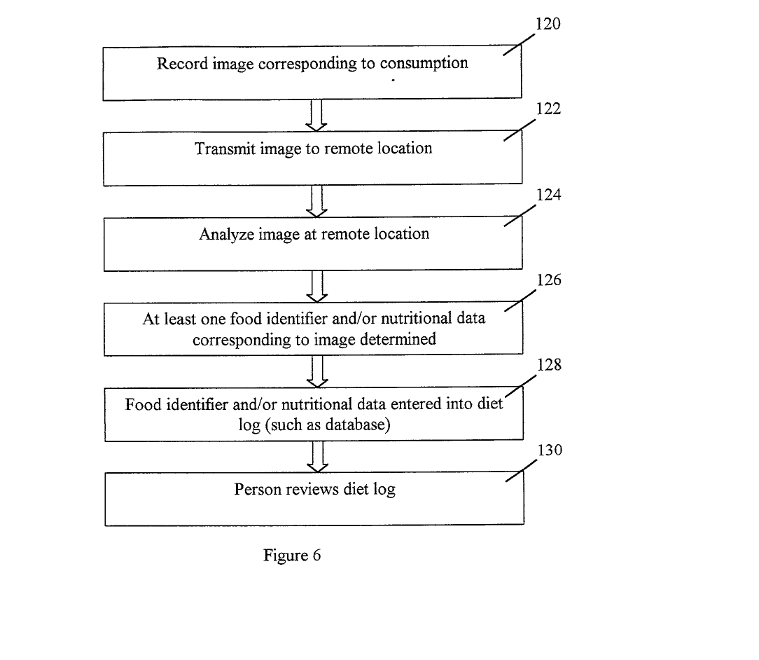

FIG. 6 is a flow chart of a method for diet logging. Box 120 corresponds to recording an image of food. Box 122 corresponds to transmission of the image to a remote location, such as a remote computer system. Other data can be transmitted with the image, for example a sales receipt, data provided by the food vendor, location the image was taken (which may be correlated with a restaurant identity), a menu image, and the weight of the food (which may be provided by a mat). Box 124 corresponds to analysis of the image of the remote location. Image recognition software may be used. A trained person, at a remote location, can select food names corresponding to the images, for example in conjunction with image recognition, providing names where image recognition has not been successful in identifying the food. A computer expert system, optical character recognition of a name on the package, barcode recognition, portion size estimate, and other food data can also be extracted from the image or images. Box 126 corresponds to determining food identity and/or nutritional content of the food within the image. Box 128 corresponds to storing the food identity and nutritional content into a database, so as to create a diet log. Box 130 corresponds to the person reviewing the diet log for accuracy at a convenient later time. Box 130 can be omitted.

### Electronic Device with Communication with Separate Entertainment Device

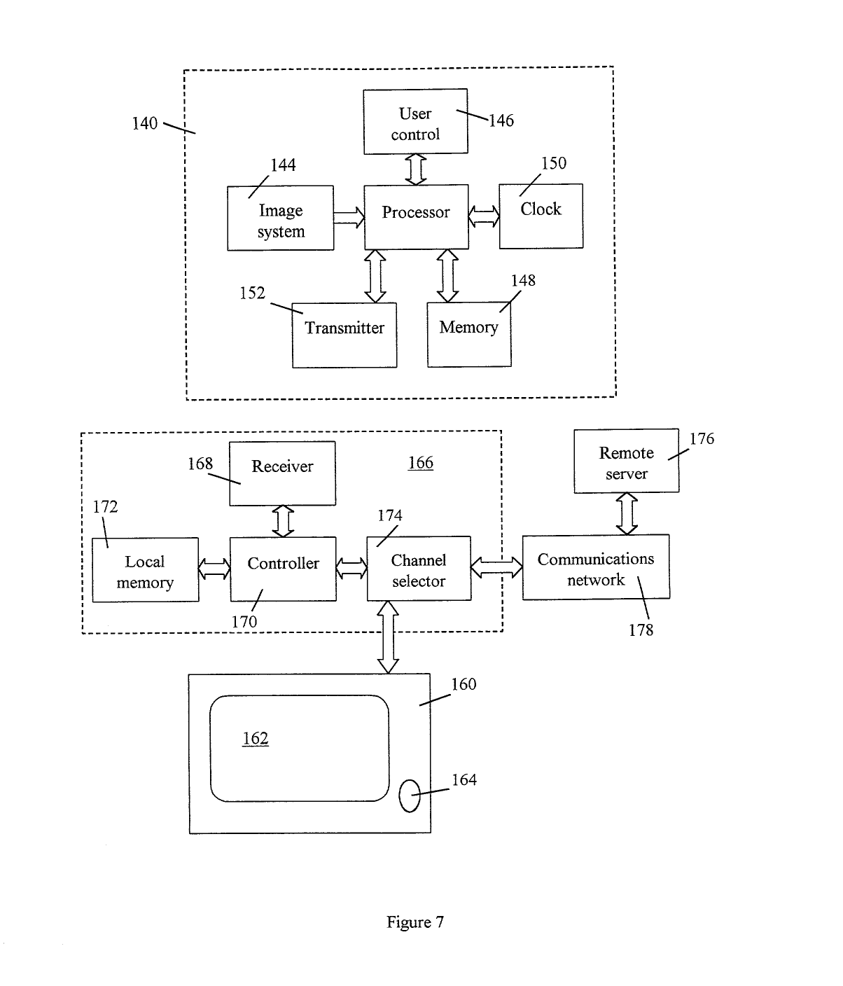

FIG. 7 shows an electronic device 140 comprising a processor 142, an image sensor 144, data entry mechanism 146, memory 148, clock 150, and wireless transmission unit 152. The electronic device 140 is used to transmit diet log data, including captured images, along with channel selection data, to a separate entertainment device. Electronic device 140 can act as a remote control for the entertainment device. In this example shown in FIG. 7, the entertainment device is an interactive television 160 having a display 162, speaker 164, and set top box 166. The set top box is used to receive data from the electronic device 140, and to control the display on display 162. A possible schematic of the set top box is shown, comprising a receiver 168, a controller 170, a local memory 172, and a channel selector 174. IR, Bluetooth, or other wireless methods can be used to transmit data from transmitter 152 to receiver 168. Data received by receiver 168 is passed to the controller 170 and interpreted. Image data can be stored in local memory 172. Channel selection data is passed to a channel selector 174. A diet log channel, generated by remote server (or other remote computer systems, or other content provider) 176, and received by the set top box over communications network 178, can be selected for display on the interactive television 160. A display of food item identifiers, such as food names in a menu format, can be displayed on the display 162 of the interactive TV 160. An image stored in the local memory 172 can be added to the diet log channel signal, using techniques known in the art, so that the person views the diet log channel with an embedded image of the food consumed. The person then selects items corresponding to the food consumed from the displayed menu. Selection data is generated with user input 146 (for example a keyboard) and transmitted to the set top box and to the remote server. The display is changed appropriately on receipt of the selection data by the content provider and the selection is added to the diet log of the person, which is stored in a database associated with or otherwise accessible by the remote server 176. Data can also be transmitted directly from the device 140 to the remote server 176 over a communications network, for example using a wireless Internet connection.

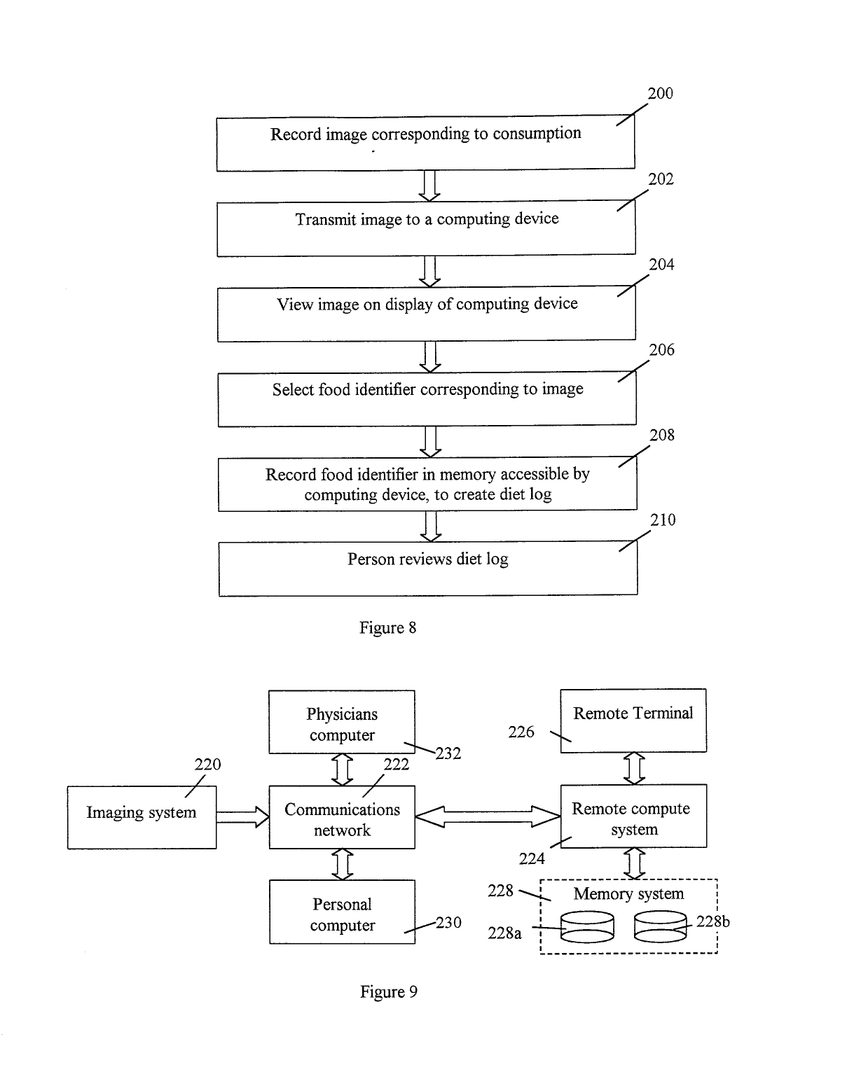

FIG. 8 is a flow chart corresponding to a method of diet logging. Box 200 corresponds to the recording of an image. Box 202 corresponds to transmitting the image to an entertainment device, such as a computer, WebTV, interactive television, and the like. Box 204 corresponds to viewing the image on the display of the entertainment device. Box 206 corresponds to selecting a food identifier corresponding to the image, using the entertainment device to display a menu of options. Box 208 corresponds to the recording of the food identifier information in the memory of the entertainment device, or memory location in communication with the entertainment device. This may be a server in communication with the entertainment device over a communications network such as the Internet. Box 210 corresponds to the person reviewing the diet log created for accuracy and editing purposes.

### Camera Transmitting to Computer

FIG. 9 shows a schematic of a system in which an imaging system 220, such as a camera, transmits images over a communications network 222 to a remote computer system 224. Images are analyzed by a person at the terminal 226, the image analysis providing a diet log for the person. The diet log is stored in database 228, which may comprise a separate diet log 228a and image log 228b. The database, diet log data, and image data are accessible by the person or other authorized person via the communications network. The person can view the diet log using a local computer, such as personal computer 230 at the person's home. A physician or other professional can view the data through computer 232. For example, a physician, trainer, fitness consultant, or other health professional may give feedback to the person based on the images and data stored within the database 228. An image analysis system, for example one comprising a computer expert system, can be used to assist identification of food items from recorded images.

### Activity Log

Image recording can also be used in creation of an activity log, for example for exercise, training, sales routes, or other purpose. The time and location can be recorded along with image capture. A person can create a log of activities using stored images, or a third party can create the log. With reference to FIG. 5, the image recording by imaging device 102 can be triggered by an activity diagnosed by activity sensor 106, physiological sensor 104 [note: check numbers], or other monitor system. The system can be used in diagnosis of anxiety disorders, by recording images along with time and location related to stressful events. Stressful events can be as diagnosed by sensor readings such as pulse rate.

The system can also be used to create an exercise log. High pulse rate as measured by a physiological sensor can be used to trigger image recording. The person then can use the images recorded to later create an exercise log. For example, if an image is shown of a stairwell, the person can enter stair climbing into an exercise log. This is useful in creating calorie balance systems.

### Video Log

Embodiments of the invention can also be implemented using recorded video images. The person can view recorded videos at a convenient later time, so as to assist the person create a diet log.

### Dimensional Analysis

Dimensional analysis can be used to determine portion sizes of foods consumed, to assist in creation of a diet log. Images of a food item can be captured from several different angles. The focusing mechanism, rangefinder, or other distance sensing mechanism can be used to assist estimation of portion size. The electronic device can have a built in scale so as to determine portion weight.

### Calorie Management System Using Electronic Device

An electronic device can be used as part of an improved calorie management system. The electronic device is used to record images, and is then used to create and store a diet log for the person. The device is also used to record exercises and other activities. The device further receives resting metabolic rate data from a metabolic rate meter such as an indirect calorimeter. Indirect calorimeters have been described in U.S. patent applications U.S. Pat. Nos. 6,135,107, 5,836,300, 5,179,958, 5,178,155, 5,038,792, and 4,917,108, incorporated herein by reference to James R. Mault, M.D. Using caloric intake values as determined from the diet log, and calorie expenditure values as recorded through the exercise log in combination with resting metabolic rate values, the person can be provided with a calorie balance. The calorie balance is the difference between caloric intake values and caloric expenditure values. For example, a person can sit down to a meal and record an image of the meal using the electronic device. The image is transmitted to a remote location where it is analyzed and converted into a caloric value. The caloric value can be transmitted back to the person, allowing the person to decide whether to eat the meal, choose another meal, or eat some portion of the meal consistent with reaching a calorie balance goal.

A person expends calories through metabolic processes. The total energy expended by the person (TEE) is the sum of resting energy expenditure (REE) and activity related energy expenditure (AEE), i.e. TEE=REE+AEE. The calorie balance for a person is determined by comparing TEE with the caloric intake of the person. If REE is known, the calorie balance may be found if caloric intake and AEE are monitored.

A person's REE can be estimated using a formula based on their height and weight. The formula can be improved by including the effects of age and gender, however the result obtained is only an estimate based on population averages. Preferably, REE is measured using an indirect calorimeter, e.g. the gas exchange monitor (GEM) invented by James R. Mault. An accurate value of REE can be determined for an individual using the GEM, e.g. as part of an improved calorie balance monitoring system.

AEE can be determined or estimated using a variety of methods. The person may record activities performed over a day, which can be converted to values of AEE using a printed tables or a database. Values of AEE for an average person performing the activities may be used, or values for a demographic sub-set. There is some loss of accuracy if typical values (for an average person are used). However, estimating AEE may still provide acceptable accuracy in TEE if an accurate value of REE is used, as REE makes a significantly larger contribution to TEE than does AEE.

An indirect calorimeter can be used to determine the metabolic rate of the person during various activities, e.g. exercising (e.g. walking, jogging, running, swimming, cycling, playing various sports, etc.) or engaged in other activities (e.g. computer operation, watching TV, housework, gardening, driving, etc.). These values may then used in determining AEE for a given day's activities.

Signals corresponding to physical activity may be obtained from a physical activity sensor, such as a pedometer, body mounted accelerometers, etc. These signals can be calibrated against accurate metabolic rate values determined using an indirect calorimeter, or against typical energy expenditures for the activities, and used to determine AEE.

Signals related to activity levels may also be obtained from physiological sensors, e.g. respiration, temperature, and heart rate sensors. Physiological sensors may also be used to detect eating, and hence improve diet logging accuracy.

Embodiments of the present invention allow caloric intake to be determined more accurately. For example, a person is provided with an electronic device, e.g. a portable computer, e-book, Internet access device, personal digital assistant (PDA), wireless phone, wrist-mounted device, pager, and the like. For convenience below, we will refer to the electronic device as a PDA, though this is non-limiting. Any electronic device may be used, such as one which is portable and has computing capabilities. The system may comprise a PDA and other accessory devices, or devices which may transmit data to the PDA. As part of the system, a device may be carried by the person disguised or also comprising the functionality of another item, e.g. jewelry, a button, a writing implement, spectacles, sunglasses, clothing, belt, headband, etc. The system may also include physiological sensors.

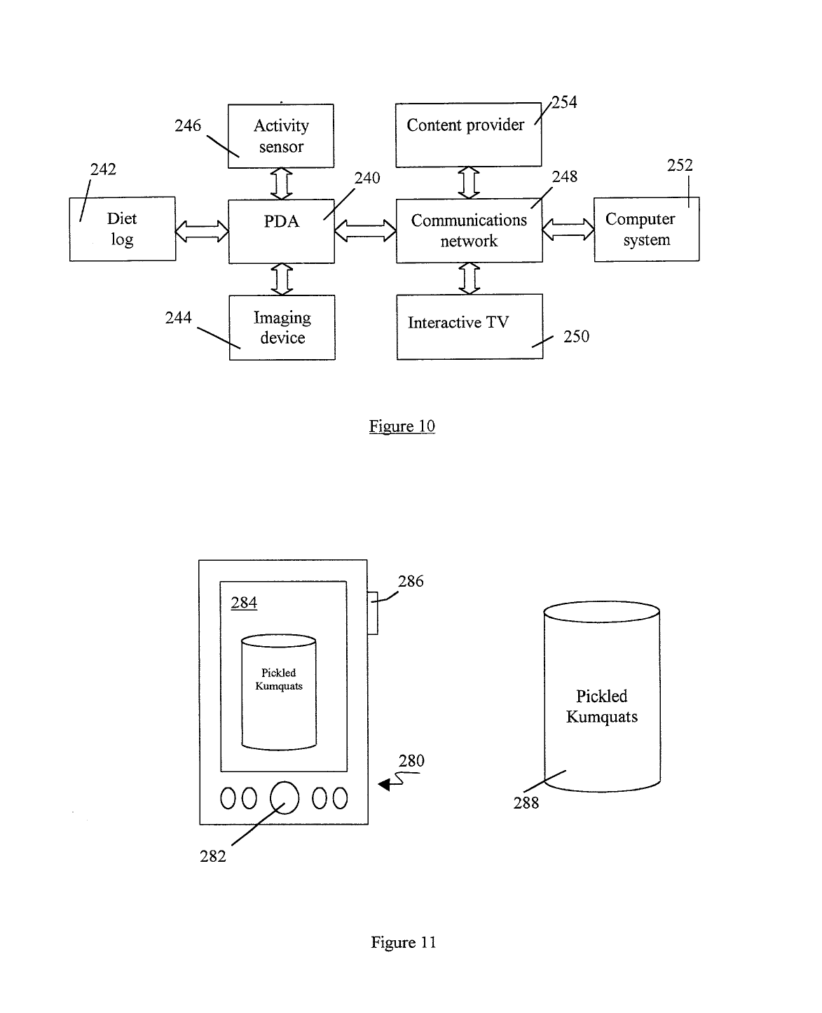

FIG. 10 illustrates a schematic of a calorie management system. PDA 240 has software used to determine the calorie balance of the person. An REE value for the person is entered into the PDA, preferably a value obtained using an indirect calorimeter. AEE is for the person is determined using a body-mounted activity sensor 246 which provides a signal related to physical activity. Signals may be transmitted to the PDA using e.g. the Bluetooth radio transmission protocol, using a nonvolatile memory medium such as a memory card, IR links, optical links, cables, wires, electrical interfaces, etc. The activity monitor may physically resemble a memory card and in use be held on the body or belt of a person, then plugged into the PDA at convenient times. In some embodiments, the PDA 240 and activity sensor 246 may be combined e.g. the PDA acting as an activity sensor when carried on a belt.

Having determined (by estimation or measurement scheme) the total value of TEE, it is necessary to record food eaten to get an accurate determination of calorie balance for a person. The information recorded may just be in the form of caloric value, but preferably additional nutritional information is recorded such as fat content, protein content, fiber content, mineral content, vitamin content, etc. so as to assist the person in achieving a healthy diet.

Food, beverage, medicine, and nutraceutical items consumed are recorded using an imaging device 244, which can be associated with the PDA, such as a built in imaging module or plug-in accessory, but a separate device such as a camera may be used. The PDA preferably includes a real time clock, so the time that the images are obtained may be recorded. The recorded images are used to create a diet log 242, which can exists in a memory of the PDA, or other device in communication with the PDA. A recent diet log (e.g. for the previous month) can be stored on the PDA, with archival and backup versions stored elsewhere. The PDA 240 is linked to a communications network 248, for example using a wireless Internet connection. The communications network can also be a local network, CATV system, telephone network, private wireless network, or other network. Recorded images, diet log information, physical activity data, and the person's weight and other useful physiological data can be transmitted from the PDA to a computer system 252, for example a remote server. The person, or other authorized people (e.g. physician, health-related business employee, dietician, personal trainer, etc.) may access the data e.g. via a website. Feedback may be provided to the person via the PDA or via another electronic device such as an interactive TV 250. Other devices may be used to provide feedback, e.g. Internet access device, Web TV, television, personal computer, pager, phone, and other electronic devices. Feedback provided to the person can controlled by the data collected by the system. The communications network 252 can be used to provide the person, via the PDA or other device, of information useful to diet logging, e.g. nutritional information of items purchased, information about prescribed drugs, etc.

Lifestyle data, comprising e.g. activity, food consumed, medications, drinks, etc., environmental conditions, etc. may be collected and stored in a database, for example in a database stored on a memory of computer system 252. The data collected may then be used to provide customized feedback to the person. For example, a TV channel may broadcast health related content. Based on a person's lifestyle, segments may be chosen and provided to the person via an interactive television. A content provider 254 provides audio-visual information viewed on the interactive TV or PDA, the content which can be modified according to the calorie balance, health, physiological status, or preference of the person, or through some other reason such as commercial requests.

The PDA 240 can be adapted to record images of items consumed. The PDA may have a built-in imaging sensor array, or may interface with an accessory device having an imaging sensor array (e.g. a plug-in accessory). A digital camera may be used to record images. Imaging and image processing methods are used to record, identify, and obtain information regarding items consumed.

For example, if the person eats a banana, they would capture an image of the banana using the PDA and record this image to memory. At a later time, the person can review the stored images, identify the food items consumed, and enter the food items into diet log software loaded on the PDA. The advantage of this method is that recording images at the time of eating is easy and convenient, and the more time-consuming process of creating a diet log of foods eaten can be postponed until time is available.

Food portion size is used in determination of the calorie content. Portion size may be determined using several methods, for example weighing, or estimation. Image analysis can also be used. Portion size can be determined from a combination of the image size and the distance to the object. The distance may be found using focusing methods, for example the IR methods commonly found on portable cameras, or range finding techniques, ultrasound methods, etc. Alternatively, a standard sized object may be included in the image, e.g. a finger of the person, a coin, a fork, a sticker, etc. Imaging can also be used to record the initial portion size of a meal, and the size of the left-overs, so that fractional servings can be estimated.

FIG. 11 shows a PDA 280 with display 284, buttons 282, and imaging device 286 directed at a can of pickles 288. The display 284 can be used to indicate the image to be captured. A button such as 282 may be pressed to record the image. The display 184 can be used to view captured images of foods stored in the memory of the PDA, for assisting the person in creating a diet log.

Image processing techniques can be used to identify food items from images. For packaged foods, optical character recognition may be used to record and identify nutritional information and/or identify the item consumed. Computer analysis of images may be carried out on the PDA or using another computer system in communication with the PDA. For example, an image of food packaging may be used to identify the food contained. An image of the nutritional content information panel provided by the manufacturer on the package may also be recorded. Optical character recognition may be used to obtain information from the image for storage in a diet log. An image of a box of corn flakes may be recognized by a computer as such, and used to generate a corn flake serving record in a diet log. Computer analysis may be used as a first attempt in producing a diet log, and if unsuccessful, the image can be passed to a human for analysis.

For non-packaged foods, e.g. restaurant meals, image analysis may also be used in identifying the food items. Imaging at a number of wavelengths, followed by false color image generation, can be used to help identify image components. Spectroscopic imaging can be used in computer-assisted food recognition.

Image processing, image recognition, and pattern recognition algorithms are useful in analyzing stored images so as to create a diet log. Algorithms may be applied to color images, or images recorded at a number of different wavelengths (e.g. in the IR, optical, and UV) which may assist identification. Stored images can be identified by comparison with previously stored images that the person has identified, using a software learning mechanism such as a neural network.

Images may be recorded on a nonvolatile memory medium, e.g. a flash card, and transferred to another electronic device for analysis, or to a dietician, physician, fitness trainer, etc. The person may carry a separate digital camera to record images. These may be transferred to the PDA or to another computer system for analysis. The portable electronic device referred to as a PDA in this specification may also be a digital camera. Images may also be transferred over a communications network to allow analysis elsewhere.

Embodiments of the present invention allow an electronic diet log to be created by any person with access to the recorded images. After recording an image using the PDA, the image may be transferred to another location using a communications network. For example, the image may be transmitted via a wireless Internet connection to another computer system. The person may subscribe to a health or diet monitoring program, e.g. through a subscription. An employee (i.e. regular employee, contractor, associate, employee of related business, etc.) of the diet monitoring business may then create a diet log for the person based on the recorded images. Medications may also be recorded and identified. The person may access the created diet log, e.g. through an Internet connection, and edit the record if necessary. An advantage of having the diet business employee create the diet log is that less biased estimates of portion sizes will be recorded as there is no incentive to underestimate them. Another advantage is that the diet log can be created quickly and with little effort on the part of the person. For example, the person enters a restaurant, chooses an item from the menu, and images the menu choice. An image of the delivered food is also captured. Images are transmitted via a wireless Internet connection to a remote server. An employee of the diet business with access to the remote server then generates a diet log entry for the person in the restaurant. A message could then be sent back to the person eating in the restaurant. For example, they may be advised not to complete the meal in order to remain on a diet program.

Barcodes can also be used in food item identification. The PDA may also incorporate a bar-code scanner, or alternatively, barcodes may be identified from a recorded image of the bar-code using image analysis. The barcode (e.g. universal product code) can be used to retrieve nutritional data relating to the item from a database. The database may reside on a remote computer system (remote in this context meaning a computer system not carried by the person, for example a commercial server system, home computer, etc.). The person may scan the barcode of a box of cereal and the UPC code used to retrieve nutrition information specific to that brand of cereal from the database. Information may be recorded on a database on the PDA, for example for items already consumed or likely to be consumed as part of a weight control period. Barcodes may also be provided on sales receipts, menus, prepackaged foods provided in a weight control program, etc. These barcodes may then be used to obtain nutrition information for the items consumed.

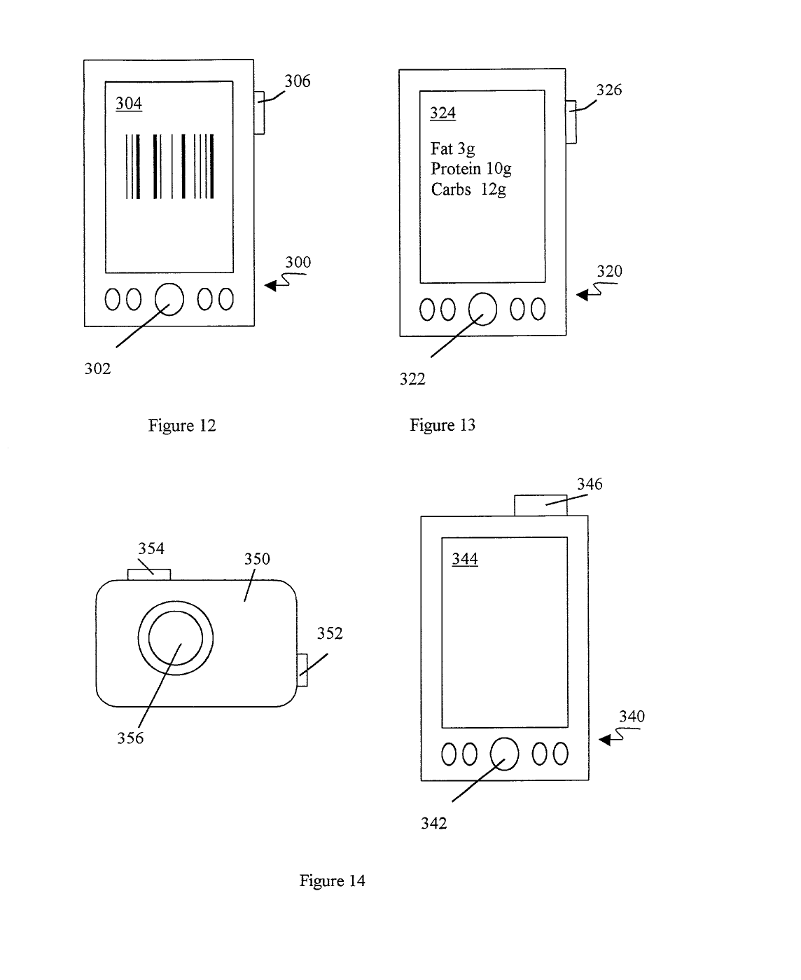

FIG. 12 shows an image of a barcode presented on the display 304 of PDA 300 (the PDA having data entry buttons 302, and an image sensor 306). Image analysis software can be used to analyze the image of the barcode, so as to determine UPC, product name, nutritional data, and the like. Alternatively, a barcode scanner can be used to read the barcode, or an accessory device which in communication with the PDA may be used as a barcode scanner.

FIG. 13 shows an image of nutritional information on the display 324 of a PDA 320, having data entry buttons 322 and optical image sensor 326. Optical character recognition software running on a processor of the PDA can be used to extract nutritional information from the image, and place it into memory for possible later transfer to a database.

Food item identities and nutritional information can also be received from food vendors, e.g. grocery stores, on-line retailers, restaurants, vending machines, diet food retailers, etc. The PDA may prompt the person to identify the source of the food being imaged, and this information can be used to help in identification. Food packages, and other food items, may carry a transponder, such as an inductively coupled transponder, or capacitively coupled transponder, which provides additional food data on interrogation, for example by electromagnetic radiation emitted by the PDA. The additional food data can be used to supplement other data, such as images and diet log entries, or to create diet log entries automatically under control of diet log software running on the PDA.

A voice recording can also stored on the PDA, to supplement image data. Audio files can be transmitted over a communications network to assist generation of a diet log. Audio files can be linked to corresponding image files, or used to add information not captured by image files.

Signals from the activity sensor may also be transmitted over a communications network. A physician, health worker, fitness trainer, diet business employee, or other person with a professional interest in the person's lifestyle may access the image data and any supplemental data to review the person's lifestyle with reference to diet goals, health goals, etc.

FIG. 14 further illustrates how a digital camera 350, having an image capture button 354, lens 356, and memory module 352, can be used in a diet logging system in combination with a PDA (or other computing device) 340, the PDA having display 344, data entry buttons 342, and a memory card slot (shown with inserted memory module 346). Memory modules, or wireless transmission, can be used to transfer image data captured using the camera to the PDA, for viewing on PDA display 344. A memory module can be plugged into appropriate memory module reader slots in the camera and PDA. In other embodiments, a camera can be used in the role of a PDA, and the memory cards can be used to transfer data to another computer. The digital camera may be in the form of a pen, watch, personal ornamentation, etc., and used to capture images which are later transferred to a computing device for analysis.

Images can be recorded to a memory module for transfer to other electronic devices. Images can further be transferred to other devices over cable links, wireless communication links, or other methods.

The PDA may also be used to prepare shopping lists, or to order goods and services over a communications network. For example, if a cereal box is empty, the barcode or image of the box may be recorded so as to add the item to an order list. Images of pills consumed may be recorded, and the prescription refilled at an appropriate time based on usage. Failure to image a prescribed pill may result in an automatic reminder. Portion sizes of e.g. cereal may be more accurately obtained by combining the known number of portions consumed from the diet log and purchase frequency information e.g. obtained from a food retailer. Failure to reach activity goals may result in an exercise session being scheduled by the PDA. Failure to reach weight goals may be used to modify food orders placed by the PDA, e.g. with a store, on-line business, diet plan food retailer, etc.

### Wrist-Mounted Device

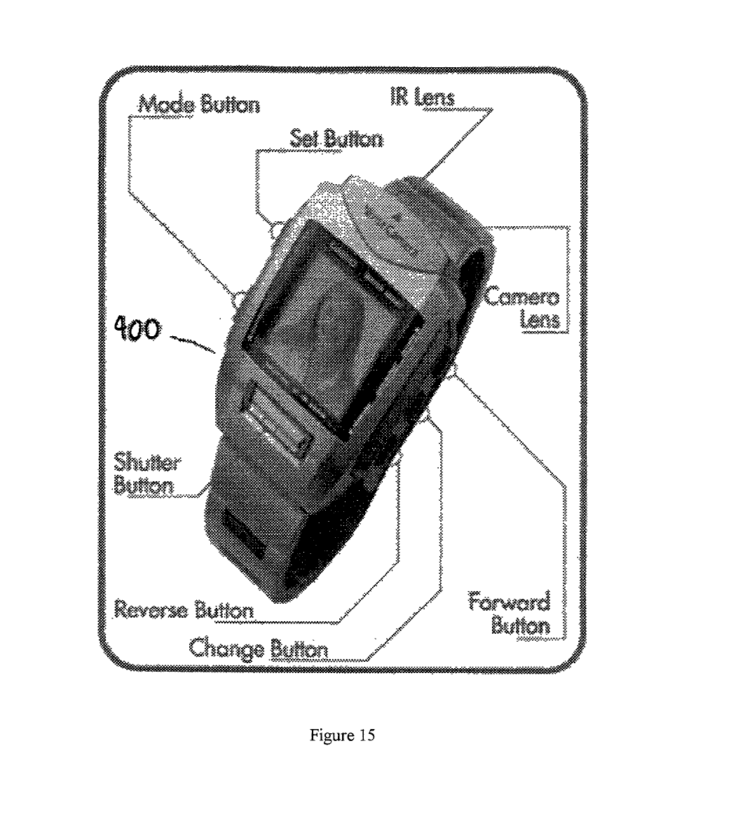

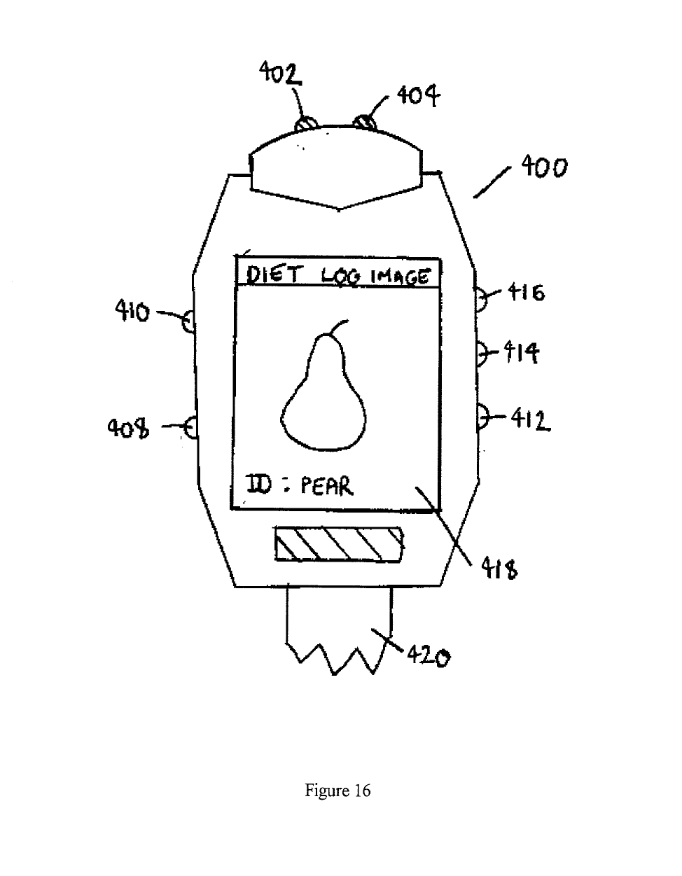

FIGS. 15 and 16 illustrate another embodiment of the present invention. A wristwatch shown generally at 400 is adapted to image-based diet logging. FIG. 6A shows a general design for such a device. Referring to FIG. 16: IR lens 402 is used as part of an IR data communications system enabling watch 400 to communicate with other devices; camera lens 404 forms part of an image sensor; shutter button 406 is pressed to capture an image or video using the image sensor; mode button 408 changes the operating mode of the device (modes may include some or all of the following: image recording, image display, video recording, video display, television, wireless, timepiece, calculator, personal organizer, wireless phone, video phone, Internet access device, diet log, activity sensor, physiological sensor (e.g. blood glucose), and any other useful function); and set button 410, reverse button 412, change button 414, forward button 416 are used in e.g. data entry and image review processes.

### Medication log

A person can record images of medicines taken, such as tablets consumed, and these images can be used to create a medical log using embodiments of the present invention. Colors, shapes, printed codes, and fluorescent markers of tablets can be used to assist identification, either by a person or an software image analysis program.

### Lifestyle Log

Images can be recorded at intervals by a device carried by the person, and the images used to create a lifestyle log for the person. This can include analysis of images of meals consumed, so as to create a diet log. Images can be recorded automatically, for example at time intervals, so as to spare the person the effort of remembering to record images of foods consumed. Image creation can be triggered by events, such as physiological parameters which change during eating, position (such as using a global positioning system), voice commands, wireless transmission from a remote device, such as a food vending machine, and the like. Recorded images can be transmitted to a remote computer system, the remote computer system being used to analyze the images using image processing methods. Recorded images can analyzed so as to determine, for example, carbon dioxide production associated with the person's lifestyle (for environmental impact determination, or carbon tax determination), natural resource use, physical activity level, risk levels (for example, for actuarial use), and the like.

### Animal Feeding Log

Embodiments of the present invention can be used to create records of foods consumed by an animal. For example, in the case of a horse, images can be captured of foods fed to the horse. The images can then be analyzed, using embodiments of the present invention, to create a diet log for the horse.

1. A method for assisting a person to create a record of foods consumed by the person, the method comprising:
creating food images corresponding to food items consumed;
recording the food images in a memory of an electronic device, the electronic device having a display, and a processor;
viewing the food images on the display of the electronic device, so as to identify food items consumed;
selecting food item identifiers corresponding to the food images viewed; and
recording the food item identifiers in the memory of the electronic device, so as to create a record of the food items consumed.

2. The method of claim 1, wherein the food item identifiers are selected from one or more menu listings viewed on the display of the electronic device.

3. The method of claim 1, wherein the food images are created using an imaging system which is part of the electronic device.

4. The method of claim 1, wherein the food images are created using an imaging system which is in communication with the electronic device.

5. A method of creating a record of a food item consumed, the method comprising:
recording a food image of the food item consumed;
viewing the food image on a display of an electronic device;
providing a food item identifier to a software application program running on the electronic device, wherein the food item identifier corresponds to the food image viewed on the display; and
recording the food item identifier in a memory of the electronic device, so as to create a record of food items consumed.

6. The method of claim 5, wherein the food image is recorded in a memory of the electronic device.

7. The method of claim 5, wherein the food item name is selected from a list of food item names presented on the display of the electronic device.

8. The method of claim 5, wherein the food item name is entered into the electronic device using a menu selection system.

9. A method of creating a diet log, comprising:
recording an image of a label, the label corresponding to a food item consumed;
analyzing the image of the label, so as to determine an identity of the food item consumed; and
storing the identity of the food item consumed in an electronic memory, so as to create a diet log.

10. The method of claim 9, wherein the label is a printed label.

11. The method of claim 9, wherein the label is a barcode.

12. The method of claim 9, wherein the label is an alphanumeric code.

13. The method of claim 9, wherein the identity of the food item consumed is correlated with nutritional data using a database, and the nutritional data is stored in an electronic memory so as to create a nutritional record for the person.

14. A method by which a person can create a record of a food consumed, the method comprising:
recording at least one image of the food consumed;
transmitting the image of the food consumed to a remote computer system;
receiving a food identification from the remote computer system; and
recording the food identification, so as to create a record of foods consumed.

15. The method of claim 14, wherein the image of the food consumed is transmitted to the remote computer system over a communications network.

16. The method of claim 14, wherein the image of the food consumed is analyzed by a software system running on the remote computer system, so as to provide the food identification.

17. The method of claim 14, wherein the image of the food consumed is analyzed by a person interacting with the remote computer system, so as to provide the food identification.

18. The method of claim 14, wherein the remote computer system comprises an image analysis system.

19. A system to assist a person determine a calorie balance for the person, comprising:
a portable computing device, having a display, a processor, a memory, a clock, and a data entry mechanism;
an imaging system, adapted to record food images of food consumed by the person; and
a software application program, executed by the processor of the portable computing device, adapted to present food images to the person on the display, to receive food identification data from the person corresponding to food images presented on the display, and to determine the caloric value of foods consumed by the person.

20. The system of claim 19, further comprising an indirect calorimeter, providing a determination of a resting metabolic rate of the person, wherein the software application program is adapted to receive the resting metabolic rate of the person.

21. The system of claim 19, further comprising an activity monitor, providing an activity signal correlated with an activity level of the person, the activity signal being transmitted to the portable computing device, the software application program being adapted to determine a caloric expenditure of the person from the activity signal.

22. A system for assisting a person create a record of foods consumed, comprising;
a computing device, comprising a processor, a memory, a clock, and a display;
an imaging system, in communication with the computing device, comprising an optical imaging sensor, and a imaging control mechanism, so as to allow the person to capture food images corresponding to foods consumed by the person; and
a software application program, executed by the processor, adapted to display food images to the person, to accept corresponding food identifier data from the person, and to store the food item identifier data in the memory, so as to create a record of foods consumed by the person.

23. The system of claim 22, wherein the software application program is further adapted to display a menu of food item identifiers to the person.

24. The system of claim 22, further comprising an activity sensor, in communication with the computing device, so as to allow a determination of activity expenditure of the person, and wherein the software application program is further adapted to calculate a calorie balance for the person.

25. The system of claim 22, further comprising a blood glucose sensor in communication with the computing device, and wherein the software application program is further adapted to predict a blood glucose level for the person.

26. The system of claim 21, further comprising a physiological sensor in communication with the computing device, the physiological sensor providing a physiological signal, wherein one or more images are automatically captured by the imaging system in response to values of the physiological signal correlated with eating.

27. A method of determining a calorie balance for a person, comprising:
determining a resting metabolic rate of the person;
determining an activity level of the person recording images corresponding to food items consumed by the person;
using the recorded images to determine the caloric intake of the person; and
determining the calorie balance of the person using the determined resting metabolic rate, the determined activity level, and the determined caloric intake of the person.
